(19) United States
(12) Patent Application Publication
(10) Pub. No.: US 2007/0279355 A1
(43) Pub. Date: Dec. 6, 2007

(54) Display Device

(76) Inventors: Masafumi Hirata, Ooamishirasato (JP); Keiichirou Ashizawa, Mobara (JP); Yoshiki Watanabe, Ootaki (JP); Hiroaki Iwato, Mobara (JP); Katsumi Ichihara, Mutsuzawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/752,320

(22) Filed: May 23, 2007

(30) Foreign Application Priority Data
May 31, 2006 (JP) 2006-151002

(51) Int. Cl. G09G 3/36

(52) U.S. Cl. 345/87

(57) ABSTRACT

The present invention enhances accuracy in feedbacking a common potential applied to common electricity supply lines. On a substrate of a display device, a plurality of scanning signal lines, a plurality of video signal lines which stereoscopically intersects the plurality of scanning signal lines by way of an insulation layer, common electricity supply lines arranged in a matrix array which intersect the plurality of scanning signal lines and the plurality of video signal lines by way of the insulation layer, and a common bus line which is arranged around an approximately quadrangular display region to surround the display region annularly and is electrically connected with the common electricity supply lines are formed. The substrate includes a common sensing line which feedbacks a voltage of the common bus line to a common voltage generating circuit, and the common sensing line is connected to a side of the common bus line opposite to a side of the common bus line to which the voltage of the common potential is applied. Further, the common sensing line is configured not to stereoscopically intersect other conductive layer formed on the substrate.

The present application claims priority from Japanese application JP2006-151002 filed on May 31, 2006, the content of which is hereby incorporated by reference into this application.

### BACKGROUND OF THE INVENTION

1. Field of the invention

The present invention relates to a display device, and more particularly to a technique which is effectively applicable to a liquid crystal display device adopting a lateral-electric-field driving method.

2. Description of Related Art

Conventionally, with respect to a liquid crystal display device which includes a liquid crystal panel formed by sandwiching a liquid crystal material between a pair of substrates, for example, there has been known a lateral-electric-field driving liquid crystal display device such as an IPS (In-Plane-System) liquid crystal display device. A liquid crystal display panel which is used in the lateral-electric-field driving liquid crystal display device forms pixel electrodes and common electrodes (also referred to as counter electrodes) on one substrate out of the pair of substrates.

Here, the common electrodes are, for example, connected with a common electricity supply line arranged in a matrix array which stereoscopically intersects a plurality of scanning signal lines or a plurality of video signal lines formed on the substrate. Here, outside a display region of the substrate, an annular common bus line which surrounds the display region is arranged, and the common electricity supply line is connected with the common bus line.

The voltage of the common potential applied to the common electricity supply line and the counter electrodes is, for example, generated by a common voltage generating circuit which is formed on a printed circuit board having a timing controller. Then, the voltage of the common potential is supplied to the common bus line from a plurality of printed circuit boards which are connected with the display panel (substrate).

Further, the common electricity supply line intersects the plurality of scanning signal lines and the plurality of video signal lines stereoscopically and hence, intersection capacitances which are generated on intersection regions generate noises and there exists a possibility that irregularities are generated with respect to a potential of the common electricity supply line (common electrodes). Accordingly, in the liquid crystal display panel of recent years, the potential of the common electricity supply line is measured, and the potential is fed back to the voltage of the generated common potential thus lowering the irregularities of potential of the common electricity supply line (common electrodes) (see patent document 1 (JP-A-2002-169138 corresponding to U.S. Pat. No. 6,756,958), for example).

However, in the conventional feedback method, for example, it is often the case that the potential of the common electricity supply line is measured at a portion thereof close to a position where the voltage of the common potential is inputted. Accordingly, the measuring common potential is influenced but little by the intersection capacitances which are generated at regions where the plurality of scanning signal lines and the plurality of video signal lines stereoscopically intersect each other thus giving rise to a drawback that the accuracy in stabilizing the potential by feedback is low. As a result, for example, there exists a drawback that, in the display region, the irregularities of image quality are generated between a portion of the common electricity supply line close to a position at which the voltage of common potential is inputted and a portion of the common electricity supply line remote from the position at which the voltage of common potential is inputted and the like.

### SUMMARY OF THE INVENTION

It is an object of the present invention to provide a technique which can enhance accuracy at the time of feeding back a common potential applied to a common electricity supply line.

The above-mentioned and other objects and novel features of the present invention will become apparent from the description of this specification and attached drawings.

To schematically explain the summary of typical inventions among inventions disclosed in this specification, they are as follows.

(1) In a display device including a pair of substrates, a plurality of scanning signal lines, a plurality of video signal lines which intersect the plurality of scanning signal lines, common electricity supply lines arranged in a matrix array which intersect the plurality of scanning signal lines and the plurality of video signal lines, a common bus line which is formed outside a display region to surround the display region and, at the same time, is electrically connected with the common electricity supply lines, and a common voltage generating circuit which generates a voltage of a common potential which is applied to the common bus line and the common electricity supply lines,

the display device includes a common sensing line which feedbacks the voltage of the common bus line to the common voltage generating circuit, and the common sensing line is connected to a side of the common bus line opposite to a side of the common bus line to which the voltage of the common potential is applied and, at the same time, the common sensing line is configured not to intersect other conductive layer formed on the substrate in a stereoscopic manner.

(2) In the display device having the constitution (1), the common voltage generating circuit includes a feedback circuit which compares a voltage of the common potential generated by the generating circuit and the common potential when the voltage of the common potential is applied to the common bus line and the common electricity supply lines, and adjusts the voltage of the common potential generated by the generating circuit.

The display device of the present invention includes the feedback circuit which measures the potentials of the common bus line and the common electricity supply line formed on the substrate of the display panel, and adjusts the voltage of the common potential generated by the common voltage generating circuit based on the measured potential. Here, the common sensing line which transmits the potentials of the common bus line and the common electricity supply lines to the feedback circuit is connected to the side of the common bus line opposite to the side of the common bus line to which the voltage of the common potential is applied, and in the path to the feedback circuit from the common bus line, the common sensing line is not configured such that the common sensing line stereoscopically intersects other conductive layers formed on the substrate. By adopting such constitution, it is possible to measure the potential on which the influence of intersection capacitance which is generated in an intersecting region between the common electricity supply line and the scanning signal line or the video signal line is reflected thus enhancing the accuracy of feedback.

Further, to the display panel, a plurality of printed circuit boards such as a COF on which a scanning driver is mounted or a COF on which a data driver is mounted is connected. Accordingly, in the path to the feedback circuit from the common bus line, to prevent the common sensing line from stereoscopically intersecting other conductive layer on the substrate or the printed circuit board, for example, the common sensing line may be configured to pass the printed circuit board a plurality of times in the path to the common voltage generating circuit from the common bus line.

Further, in general, the voltage of the common potential is applied to the common bus line such that the voltage of the common potential is applied to a first side and a second side which abut to each other at one corner of the display region such as the side on which one end portions of the scanning signal lines are arranged and the side on which one end portions of the video signal lines are arranged, for example. Accordingly, for example, when the common sensing line is connected to a third side of the common bus line opposite to the first side of the common bus line, it is desirable that a connection portion between the common sensing line and the common bus line is arranged at a position where a distance from the second side is approximately equal to or more than one half of the third side in length.

Further, the present invention is applicable to a display device of any constitution provided that the display device includes the common electricity supply lines arranged in a matrix array which stereoscopically intersect the scanning signal lines or the video signal lines. However, it is particularly desirable to apply the present invention to a liquid crystal display device having a lateral-electric-field liquid crystal display panel.

### BRIEF DESCRIPTION OF THE DRAWINGS

FIG. 1 is a perspective plan view of a liquid crystal display panel as viewed from a viewer side;

FIG. 2 is a schematic cross-sectional view taken along a line A-A′ in FIG. 1;

FIG. 3 is a schematic plan view showing a constitutional example of one pixel in a display region on a TFT substrate of the liquid crystal display panel;

FIG. 4 is a schematic cross-sectional view taken along a line B-B′ in FIG. 3;

FIG. 5 is a schematic cross-sectional view taken along a line C-C′ in FIG. 3;

FIG. 6 is a schematic view showing the schematic constitution of a liquid crystal display device of one embodiment according to the present invention;

FIG. 7 is a schematic plan view for explaining the constitution of a common bus line in a region P1 shown in FIG. 6; and

FIG. 8 is a schematic waveform diagram for explaining the manner of operation and advantageous effects of the liquid crystal display device of this embodiment.

### DESCRIPTION OF THE PREFERRED EMBODIMENT

Hereinafter, the present invention is explained in detail in conjunction with an embodiment by reference to the drawings. Here, in all drawings for explaining the embodiment, parts having identical functions are given same symbols and their repeated explanation is omitted.

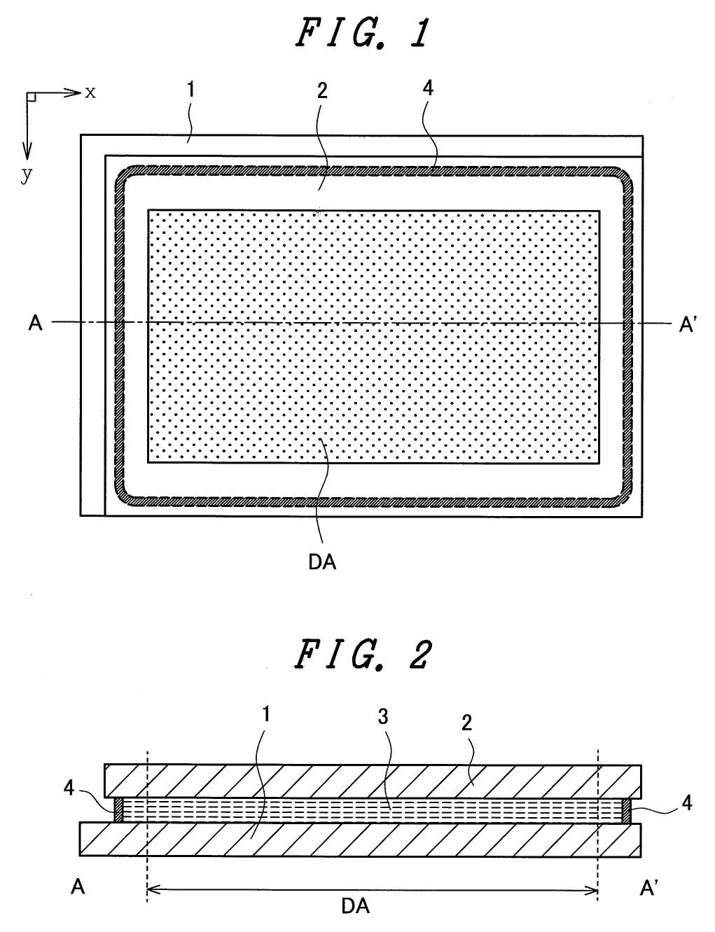

FIG. 1 to FIG. 5 are schematic views showing one constitutional example of a display panel to which the present invention is applied.

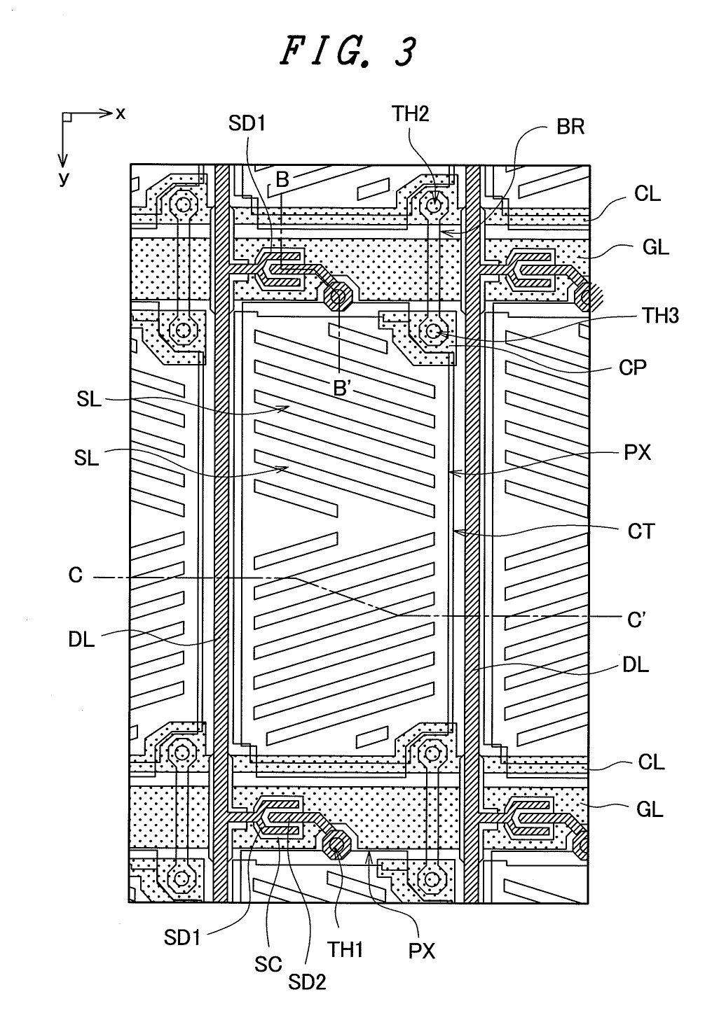

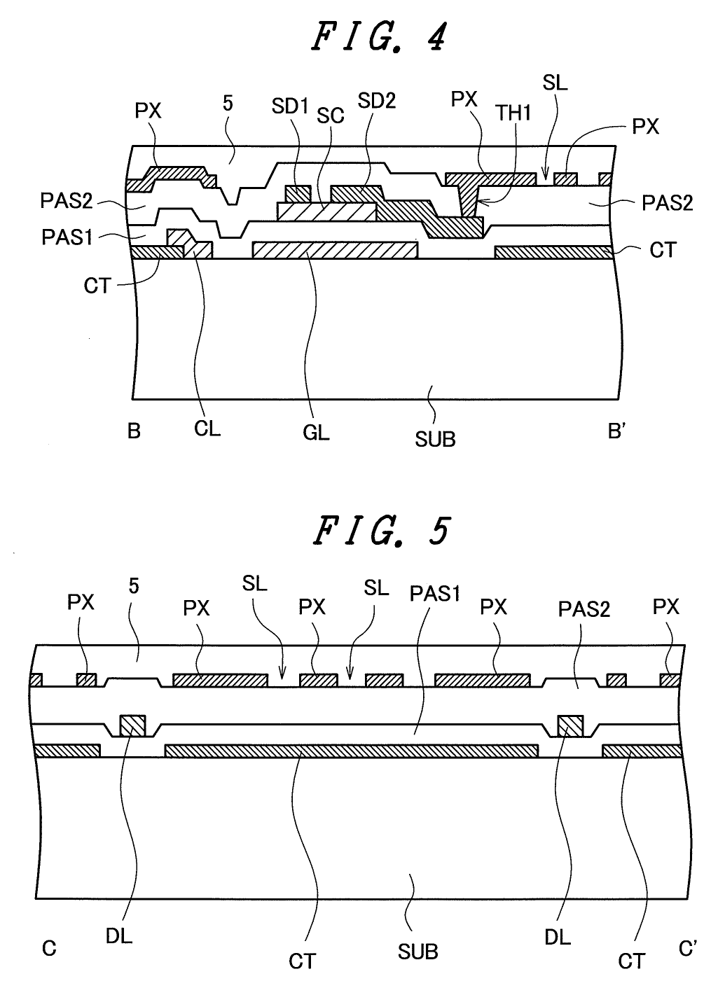

FIG. 1 is a perspective plan view of a liquid crystal display panel as viewed from a viewer side. FIG. 2 is a schematic cross-sectional view taken along a line A-A′ in FIG. 1. FIG. 3 is a schematic plan view showing a constitutional example of one pixel in a display region on a TFT substrate of the liquid crystal display panel. FIG. 4 is a schematic cross-sectional view taken along a line B-B′ in FIG. 3. FIG. 5 is a schematic cross-sectional view taken along a line C-C′ in FIG. 3.

The present invention relates to a display panel which forms a plurality of scanning signal lines and a plurality of video signal lines on a substrate thereof, and also forms common electricity supply lines which stereoscopically intersect the scanning signal lines or the video signal lines on the substrate. As such a display panel, there exists a lateral-electric-field driving liquid crystal display panel such as an IPS liquid crystal display panel.

The liquid crystal display panel is, for example, as shown in FIG. 1 and FIG. 2, a display panel which seals a liquid crystal material 3 between a pair of substrates 1, 2. Here, the pair of substrates 1, 2 is adhered to each other with a sealing material 4 which is annularly arranged outside a display region DA. The liquid crystal material 3 is sealed in a space surrounded by the pair of substrates 1, 2 and the sealing material 4.

Out of the pair of substrates 1, 2, the substrate 1 having a larger profile size as viewed form a viewer is generally referred to as a TFT substrate. Although not shown in FIG. 1 and FIG. 2, the TFT substrate 1 is configured such that on a surface of a transparent substrate such as a glass substrate, the plurality of scanning signal lines, and the plurality of video signal lines which stereoscopically intersect the plurality of scanning signal lines by way of an insulation layer are formed. A region which is surrounded by two neighboring scanning signal lines and two neighboring video signal lines corresponds to one pixel region, a TFT element, a pixel electrode and the like are arranged for each pixel region. Further, another substrate 2 which makes the pair with the TFT substrate 1 is generally referred to as a counter substrate.

Further, when the liquid crystal display panel adopts a lateral-electric-field driving method such as an IPS method, common electrodes (also referred to as counter electrodes) which face the pixel electrodes on the TFT substrate 1 are formed on the TFT substrate 1 side.

Next, a constitutional example of one pixel of the display region DA of the liquid crystal display panel adopting the lateral-electric-field driving method is briefly explained in conjunction with FIG. 3 to FIG. 5.

In the liquid crystal display panel adopting the lateral-electric-field driving method, the pixel electrodes and the counter electrodes are formed on the TFT substrate 1 side. Here, the TFT substrate 1 is, for example, as shown in FIG. 3 to FIG. 5, configured such that on a surface of the glass substrate SUB, the plurality of scanning signal lines GL which extends in the x direction is formed, and over the scanning signal lines GL, the plurality of video signal lines DL which extends in the y direction and stereoscopically intersects the plurality of scanning signal lines GL by way of a first insulation layer PAS1 are formed. Further, the region which is surrounded by two neighboring scanning signal lines GL and two neighboring video signal lines DL corresponds to one pixel region.

Further, on the surface of the glass substrate SUB, for example, a planar common electrode CT is formed for every pixel region. Here, the common electrodes CT of the respective pixel regions arranged in the x direction are electrically connected with each other by a common signal line CL arranged parallel to the scanning signal line GL. Further, as viewed from the scanning signal line GL, on a side opposite to the direction along which the common signal line CL is arranged, a common connection pad CP which is electrically connected with the common electrode CT is provided.

Further, over the first insulation layer PAS1, besides the video signal lines DL, semiconductor layers, drain electrodes SD1 and source electrode SD2 are formed. Here, the semiconductor layers are formed using amorphous silicon (a-Si), for example. The semiconductor layers are constituted of not only semiconductor layers having a function of channel layers SC of TFT elements which are arranged for respective pixel regions and semiconductor layers which prevent short-circuiting between the scanning signal lines GL and the video signal lines DL at regions where the scanning signal lines GL and the video signal lines DL stereoscopically intersect with each other (not shown in the drawing). Here, to the semiconductor layer which has the function of the channel layer SC of the TFT elements, both of the drain electrode SD1 and the source electrode SD2 which are connected to the video signal line DL are connected.

Further, over a surface (layer) on which the video signal lines DL and the like are formed, the pixel electrodes PX are formed by way of a second insulation layer PAS2. The pixel electrodes PX are electrodes which are arranged independently for respective pixel regions, wherein the pixel electrode PX is electrically connected with the source electrode SD2 at an opening portion (through hole) TH1 which is formed in the second insulation layer PAS2. Further, when the common electrode CT and the pixel electrode PX are, as shown in FIG. 3 to FIG. 5, arranged in a stacked manner by way of the first insulation layer PAS1 and the second insulation layer PAS2, the pixel electrode PX is formed of a comb-teeth electrode in which slits SL are formed.

Further, over the second insulation layer PAS2, besides the pixel electrodes PX, for example, bridge lines BR each of which electrically connecting two common electrodes CT arranged vertically with the scanning signal line GL sandwiched therebetween are formed. Here, the bridge line BR is connected with the common signal line CL and a common connection pad CP which are arranged with the scanning signal line GL sandwiched therebetween via through holes TH2, TH3.

Further, over the second insulation layer PAS2, an orientation film 5 is formed to cover the pixel electrodes PX and the bridge lines BR. Here, although not shown in the drawing, the counter substrate 2 is arranged to face the surface of the TFT substrate 1 on which the orientation film 5 is formed.

Hereinafter, a constitutional example in which the present invention is applied to the liquid crystal display device having the liquid crystal display panel in which one pixel is configured as shown in FIG. 3 to FIG. 5, and the manner of operation and advantageous effects of the constitutional example are explained.

### EMBODIMENT

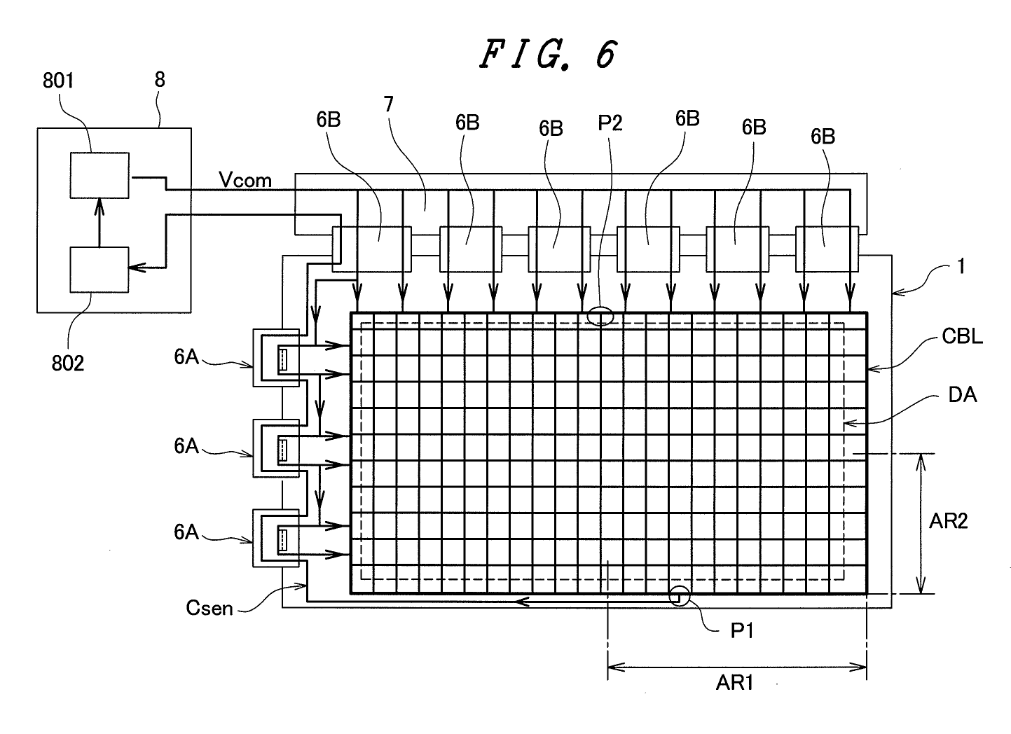

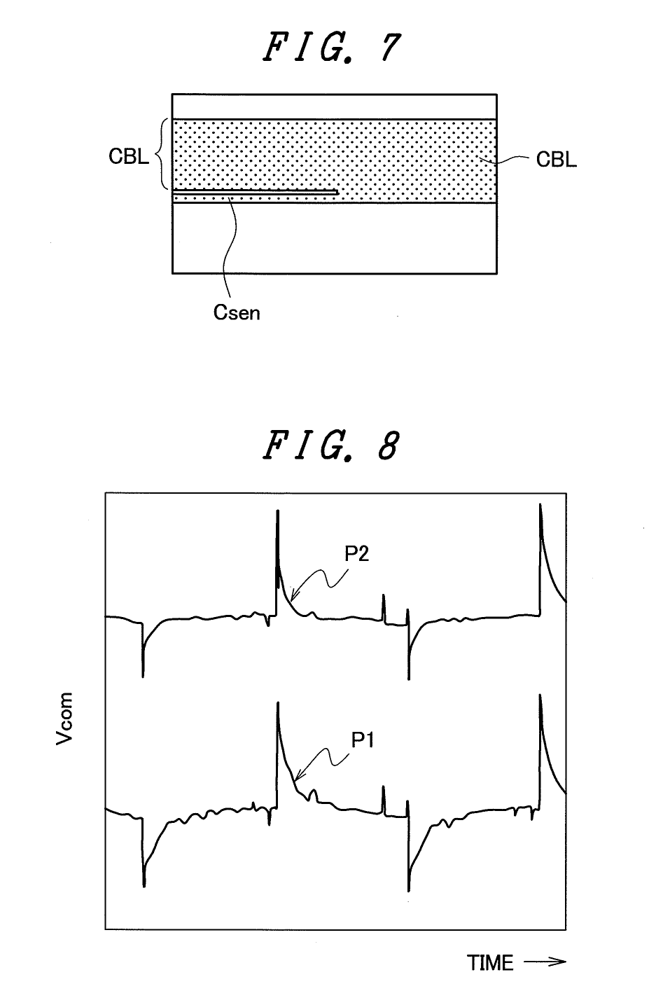

FIG. 6 is a schematic view showing the schematic constitution of a liquid crystal display device of one embodiment according to the present invention. FIG. 7 is a schematic plan view for explaining the constitution of a common bus line in a region P1 shown in FIG. 6.

In the liquid crystal display device of this embodiment, over the TFT substrate 1 of the liquid crystal display panel, for example, common electricity supply lines which longitudinally traverse the display region DA shown in FIG. 6 and common electricity supply lines which laterally traverse the display region DA shown in FIG. 6 are arranged in a matrix array. Here, the common electricity supply lines which longitudinally traverse the display region DA are, for example, constituted of the bridge lines BR and the common electrodes CT. On the other hand, the common electricity supply lines which laterally traverse the display region DA are constituted of the common signal lines CL which are arranged in parallel with the scanning signal lines GL. Further, the common electricity supply lines which are arranged in the display region DA in a matrix array are connected to a common bus line CBL which is annularly arranged outside the display region DA.

Further, a plurality of flexible printed circuit boards 6A such as COFs on which scanning driver ICs are mounted are connected to, for example, one side of the TFT substrate 1, while a plurality of flexible printed circuit boards 6B such as COFs on which data driver ICs are mounted are connected to another side of the TFT substrate 1 which abuts to the above-mentioned one side. Further, the flexible printed circuit boards 6B are connected with another printed circuit board 7. Further, the printed circuit board 7 is connected to a circuit board 8 which includes a common voltage generating circuit 801, a feedback circuit 802, a timing controller (not shown in the drawing) and the like.

In the liquid crystal display device of this embodiment, a voltage of a common potential generated by the common voltage generating circuit 801 is supplied to the common bus line CBL of the TFT substrate 1 via the printed circuit board 7 and the flexible printed circuit boards 6A, 6B. Here, a common sensing line Csen is connected to the common bus line CBL. The common sensing line Csen is provided for measuring a potential of the common bus line CBL and the common electricity supply lines and for adjusting the voltage of the common potential generated by the common voltage generating circuit 801. The common sensing line Csen is connected to the feedback circuit 802 via the flexible printed circuit boards 6A, 6B and the printed circuit board 7.

Further, the common sensing line Csen is, for example, as shown in FIG. 6, connected to a side of the common bus line CBL opposite to a side of the common bus line CBL to which the voltage of the common potential is inputted by way of the flexible printed circuit board 6B out of four sides of the common bus line CBL. Further, a connection point P1 of the common sensing line Csen with the common bus line CBL is preferably set within a region AR1 in which, for example, a distance from the side to which the voltage of the common potential is inputted from the flexible printed circuit board 6A becomes equal to or more than one half of the length of the side to which a common sensing line Csen is connected.

Here, in FIG. 6, the common sensing line Csen is connected to the side of the common bus line CBL opposite to the side of the common bus line CBL to which the voltage of the common potential is inputted from the flexible printed circuit board 6B. However, the present invention is not limited to such an electrical connection and it is needless to say that the common sensing line Csen may be connected to the side of the common bus line CBL opposite to the side of the common bus line CBL to which the voltage of the common potential is inputted from the flexible printed circuit board 6A. In this case, it is desirable that the common sensing line Csen is connected to the common bus line CBL within a region AR2 such that a distance from the side to which the voltage of the common potential is inputted from the flexible printed circuit board 6B becomes equal to or more than one half of a length of the side of the common bus line CBL to which the common sensing line Csen is connected.

Further, as shown in FIG. 7, the common sensing line Csen may be arranged outside the common bus line CBL by branching from the common bus line CBL, and is pulled around to a region of the TFT substrate 1 to which the flexible printed circuit board 6A is connected along an outer periphery of the common bus line CBL. Here, the common sensing line Csen is pulled around such that the common sensing line Csen is configured not to stereoscopically intersect other conductive layer formed on the TFT substrate 1. Accordingly, for example, as shown in FIG. 6, the common sensing line Csen may be configured such that the common sensing line Csen is led to the flexible printed circuit board 6B via the flexible printed circuit board 6A and is connected to the feedback circuit 802 via the printed circuit board 7.

The feedback circuit 802 compares the potential of the common bus line CBL and the common electricity supply lines measured (acquired) by the common sensing line Csen with a reference potential generated by the common voltage generating circuit 801 and calculates the degree of irregularities of potential. When the irregularities of potential are equal to or more than a threshold value, for example, the voltage of the common potential is generated by the common voltage generating circuit 801 based on the difference between the measured potential and the reference potential such that the potential of the measured common bus line CBL and the common electricity supply lines becomes the reference potential.

FIG. 8 is a schematic waveform diagram for explaining the manner of operation and advantageous effects of the liquid crystal display device of this embodiment. Here, in the waveform diagram shown in FIG. 8, time is taken on an axis of abscissas, and the common potential (Vcom) which is measured on the display panel is taken on an axis of ordinates.

In the liquid crystal display device of this embodiment, in the same manner as the conventional liquid crystal display device, a waveform of the common voltage at a portion close to a position at which the voltage of the common potential is inputted, for example, the waveform of the common voltage in the region P2 shown in FIG. 6 exhibits a waveform on an upper side of FIG. 8, for example. Since the region P2 is arranged close to the position at which the voltage of the common potential is inputted, the voltage of the common potential is hardly influenced by intersection capacitance which is generated in regions at which the common electricity supply lines and the scanning signal lines or the video signal lines which are formed on the display region DA in a matrix array intersect with each other stereoscopically thus forming waveforms with small noises.

On the other hand, as in the case of the liquid crystal display device of this embodiment, the waveform of the common potential at a portion remote from the position at which the voltage of the common potential is inputted, for example, the waveform of the common potential in the region P1 shown in FIG. 6 assumes a waveform shown in a lower side of FIG. 8. That is, in the liquid crystal display device of this embodiment, it is possible to perform the feedback operation based on the waveform to which noises are applied due to the influence of the intersection capacitance which is generated in the regions where the common electricity supply lines arranged on the display region DA in a matrix array stereoscopically intersect the scanning signal lines or the video signal lines. Accordingly, it is possible to efficiently correct the irregularities of potential attributed to noises and hence, it is possible to stabilize the potential of the common electricity supply lines (counter electrodes CT) with high accuracy.

Although the present invention has been specifically explained in conjunction with the embodiment heretofore, it is needless to say that the present invention is not limited to the above-mentioned embodiment and various modifications are conceivable without departing from the gist of the present invention.

What is claimed is:

1. A display device comprising:
a pair of substrates;
a plurality of scanning signal lines;
a plurality of video signal lines which intersect the plurality of scanning signal lines;
common electricity supply lines arranged in a matrix array which intersect the plurality of scanning signal lines and the plurality of video signal lines;
a common bus line which is formed outside a display region to surround the display region and, at the same time, is electrically connected with the common electricity supply lines; and
a common voltage generating circuit which generates a voltage of a common potential which is applied to the common bus line and the common electricity supply lines, wherein
the display device includes a common sensing line which feedbacks the voltage of the common bus line to the common voltage generating circuit, and
the common sensing line is connected to a side of the common bus line opposite to a side of the common bus line to which the voltage of the common potential is applied and, at the same time, the common sensing line is configured not to intersect other conductive layer formed on the substrate in a stereoscopic manner.

2. A display device according to claim 1, wherein the common voltage generating circuit includes a feedback circuit which compares a voltage of the common potential generated by the generating circuit and the common potential when the voltage of the common potential is applied to the common bus line and the common electricity supply lines, and adjusts the voltage of the common potential generated by the generating circuit.

3. A display device according to claim 2, wherein a plurality of printed circuit boards is connected to the substrate, and the common sensing line, in a path to the common voltage generating circuit from the common bus line, passes the printed circuit board a plurality of times and is configured not to intersect other conductive layer stereoscopically also on the printed circuit boards.

4. A display device according to claim 2, wherein the display device is configured to form a rectangular display region on the substrate,
the voltage of the common potential is applied to the common bus line from a first side and a second side which abut to each other at one corner of the display region,
the common sensing line is connected to a third side on a side opposite to the first side of the common bus line, and
a length of a distance to a connection portion between the common sensing line and the common bus line from the second side is equal to or more than one half of a length of the third side.

5. A display device according to claim 3, wherein the display device is configured to form a rectangular display region on the substrate,
the voltage of the common potential is applied to the common bus line from a first side and a second side which abut to each other at one corner of the display region,
the common sensing line is connected to a third side on a side opposite to the first side of the common bus line, and
a length of a distance to a connection portion between the common sensing line and the common bus line from the second side is equal to or more than one half of a length of side of the third side.

6. A display device according to claim 1, wherein the substrates constitute a liquid crystal display panel which seals liquid crystal between the substrates.
